(19) United States
(12) Patent Application Publication
(10) Pub. No.: US 2025/0067621 A1
(43) Pub. Date: Feb. 27, 2025

(54) Dynamic Test Device and Control Method for Same

(71) Applicant: SAGINOMIYA SEISAKUSHO, INC., Tokyo (JP)

(72) Inventors: Eisei In, Sayama-shi (JP); Kohei Hizono, Sayama-shi (JP)

(21) Appl. No.: 18/723,587

(22) PCT Filed: Jul. 28, 2022
(86) PCT No.: PCT/JP2022/029155

§ 371 Date: Jun. 24, 2024

(30) Foreign Application Priority Data
Dec. 27, 2021 (JP) 2021-212615

(51) Int. Cl. G01M 7/02

(52) U.S. Cl. CPC G01M 7/022

(57) ABSTRACT

An electrodynamic vibration testing system for shaking a specimen comprises a fixed section, a movable section which can reciprocate in a predetermined direction with respect to the fixed section, a voice coil motor for driving the movable section, a table attached to the movable section for fixing the specimen, an air spring which supports the movable section to the fixed section from below, and a reaction plate attached to the fixed section for sandwiching the specimen between the table, and the reaction plate.

### CROSS-REFERENCE TO RELATED APPLICATIONS

This application is the United States national phase of International Patent Application No. PCT/JP2022/029155 filed Jul. 28, 2022, and claims priority to Japanese Patent Application No. 2021-212615 filed Dec. 27, 2021, the disclosures of which are hereby incorporated by reference in their entireties.

### BACKGROUND OF THE INVENTION

### Field of the Invention

The present invention relates to a dynamic test device and a control method for same, and particularly relates to a technology of controlling the air pressure that bears the load from a test piece to be vibrated.

### Description of Related Art

Conventionally, it has been known to perform a vibration test in a dynamic test device while applying a static load to a test piece by air pressure. Patent Literature 1 describes setting a static load to be borne by air pressure (air spring) to balance the weight of a test piece and a movable unit that holds and vibrates the test piece, and controlling the static load by the air spring to be constant during vibration.

### CITATION LIST

### Patent Literature

PTL 1: Japanese Domestic Republication of PCT International Application No. 2009-130818

### SUMMARY OF THE INVENTION

### Technical Problem

However, in a dynamic test device described in Patent Literature 1, the control of vibration by a voice coil motor to the movable unit and the test piece and the control of the static load to be borne by the air spring are performed independently to each other. Therefore, for example, when performing a vibration test with a low-frequency vibration input signal or a vibration test where a vibration load varies quasi-statically, there is a possibility that control becomes unstable due to the difference between the respective frequency characteristics (responsiveness) of the voice coil motor and the air spring.

The present invention has been made to solve the above-described problem, and an object of the present invention is to provide a dynamic test device and a control method for same that eliminate control instability that occurs when controlling the static load applied by the air spring.

### Solution to Problem

In order to achieve the above-described object, a dynamic test device that vibrates a test piece according to the present invention includes a vibration portion including a holding portion capable of holding the test piece, and configured to be able to reciprocate the holding portion holding the vibration portion, electrodynamic first vibration means that reciprocates the vibration portion to vibrate the vibration portion, pneumatic second vibration means that reciprocates the vibration portion to vibrate the vibration portion, and control means for controlling the first vibration means and the second vibration means to vibrate the vibration portion, wherein the control means controls the first vibration means and the second vibration means based on the same control signal, so that individual vibration by the first vibration means and the second vibration means is performed in a quasi-static region of vibration.

Additionally, in order to achieve the above-described object, a control method of a dynamic test device that vibrates a test piece according to the present invention includes preparing a vibration portion including a holding portion capable of holding the test piece, and configured to be able to reciprocate the holding portion holding the test piece, electrodynamic first vibration means that reciprocates the vibration portion to vibrate the vibration portion, and pneumatic second vibration means that reciprocates the vibration portion to vibrate the vibration portion, controlling the first vibration means and the second vibration means to vibrate the vibration portion, and controlling the first vibration means and the second vibration means based on the same control signal, so that individual vibration by the first vibration means and the second vibration means is performed in a quasi-static region of vibration.

### Advantageous Effect of Invention

According to the dynamic test device and the control method of the dynamic test device of the present invention, control instability that occurs when controlling the static load applied by the air spring can be eliminated.

### BRIEF DESCRIPTION OF THE DRAWINGS

The terms Fig., Figs., Figure, and Figures are used interchangeably in the specification to refer to the corresponding figures in the drawings.

FIG. 1 is a block diagram representing a general overview of a control system of a dynamic test device of an embodiment of the present invention.

FIG. 2 is a schematic diagram of the dynamic test device of the embodiment of the present invention.

FIG. 3 is a schematic diagram of a linear actuator used in a dynamic test device of another embodiment of the present invention.

FIG. 4A is a graph representing the variation over time in displacement that is a target in a control apparatus in a case of performing a test by using the displacement as a target value.

FIG. 4B is a graph illustrating the variation over time in the force generated by the actuator in the case of performing the test by using the displacement as the target value.

FIG. 5 is a graph illustrating the variation over time in the load produced in the case of performing the test by using the load as the target value.

FIG. 6 is a block diagram representing the control system of the dynamic test device of the embodiment of the present invention.

FIG. 7A is a gain diagram illustrating the characteristics of each block, which are simulation results representing the response of the control system under specific conditions of a control system model in FIG. 6.

FIG. 7B is a phase diagram illustrating the characteristics of each block, which are simulation results representing the response of the control system under the specific conditions of the control system model in FIG. 6.

FIG. 8A is a graph illustrating the change in an output ratio with respect to the change in frequency in a case of K=3, T₀=1.592, and f₀=0.1 (Hz), which are simulation results of the control system in FIG. 6 in a case where a gain K, a time constant T₀, and a cutoff frequency f₀ are changed.

FIG. 8B is a graph illustrating the change in the output ratio with respect to the change in the frequency in a case of K=3, T₀=0.531, and f₀=0.3 (Hz), which are simulation results of the control system in FIG. 6 in a case where the gain K, the time constant T₀, and the cutoff frequency f₀ are changed.

FIG. 8C is a graph illustrating the change in the output ratio with respect to the change in the frequency in a case of K=5, T₀=0.796, and f₀=0.2 (Hz), which are simulation results of the control system in FIG. 6 in a case where the gain K, the time constant T₀, and the cutoff frequency f₀ are changed.

FIG. 8D is a graph illustrating the change in the output ratio with respect to the change in the frequency in a case of K=5, T₀=0.318, and f₀=0.5 (Hz), which are simulation results of the control system in FIG. 6 in a case where the gain K, the time constant T₀, and the cutoff frequency f₀ are changed.

FIG. 9A is a graph illustrating the change in a required vibration force over time in a case where a static vibration force is applied.

FIG. 9B is a graph illustrating the change in an electric vibration force over time in the case where the static vibration force is applied.

FIG. 9C is a graph illustrating the change in a vibration force by air pressure over time in the case where the static vibration force is applied.

FIG. 10A is a graph illustrating the change in a required vibration force over time in a case where a quasi-static vibration force is applied.

FIG. 10B is a graph illustrating the change in an electric vibration force over time in the case where the quasi-static vibration force is applied.

FIG. 10C is a graph illustrating the change in a vibration force by air pressure over time in the case where the quasi-static vibration force is applied.

### DESCRIPTION OF EMBODIMENTS

Hereinafter, embodiments of the present invention will be described in detail by using the drawings.

### General Configuration of Control System

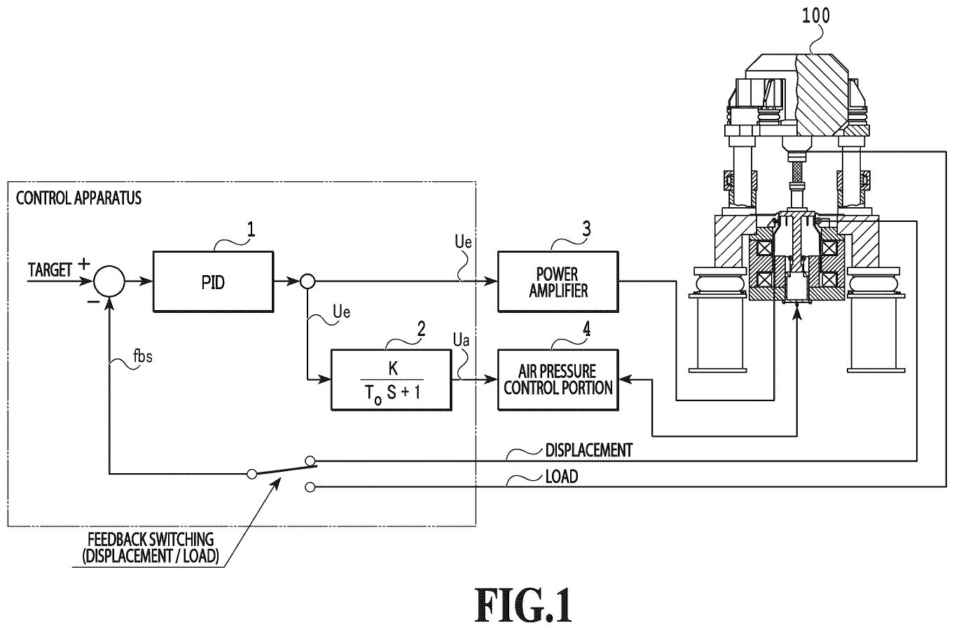

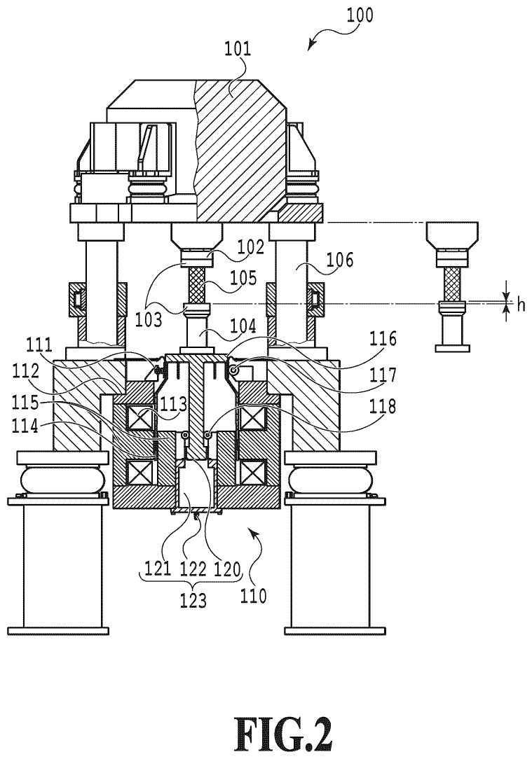

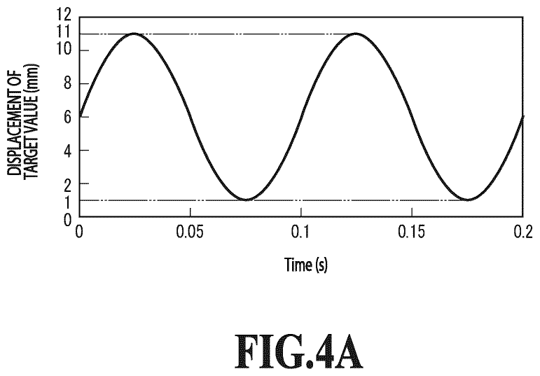

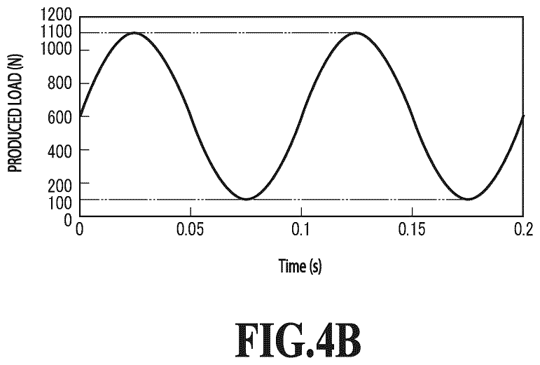

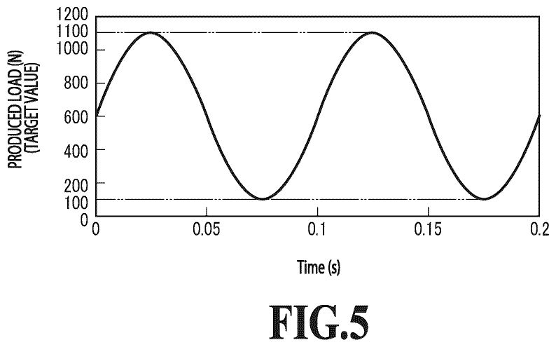

FIG. 1 is a block diagram illustrating a control system of a dynamic test device 100 according to an embodiment of the present invention, and illustrates the flow of a control signal that is input and output to and from the dynamic test device 100 and each block constituting the control system. The difference between the control signal of a target value that is input to the control apparatus of the dynamic test device 100 and a feedback signal fbs is calculated, and a differential signal is input to a PID control portion 1. A signal Ue to which PID control has been performed by the PID control portion 1 is input to each of a power amplifier 3 and a filtering portion 2. Here, the target value takes a different mode depending on the kind or object of a dynamic test as an example of which will be described later for FIG. 4 and FIG. 5. Additionally, the feedback signal fbs is switched its content depending on the kind of the dynamic test. In the filtering portion 2, a transfer function is represented by K/(T₀S+1) of a first-order lag system, and constitutes a low pass filter as will be described later. Note that, although the filtering portion 2 is realized by software in the present embodiment, it is not limited to this mode, and may be realized by other well-known configurations. The power amplifier 3 generates an amplified signal according to the signal Ue that is input, and supplies the amplified signal to an actuator of the dynamic test device 100. Accordingly, the actuator can generate vibration according to the control signal of the target value for a vibration table, which will be described later for FIG. 2. Additionally, the signal Ua from the filtering portion 2 is input to an air pressure control portion 4, and according to this signal Ua, the air pressure control portion 4 controls the air pressure of an air receiving portion (air spring), which will be described later for FIG. 2.

The vibration of a test piece held by a holding jig is sensed by a sensor, and is fed back as the feedback signal fbs. This feedback signal switches a feedback mode so that the value of displacement is fed back when the initial position is determined by displacement of the test piece, and the value of load is fed back when the initial position is determined by the load applied to the test piece.

### Overview of Dynamic Test Device

FIG. 2 is a schematic diagram illustrating a partial cross-section of the dynamic test device 100 of the embodiment of the present invention. The dynamic test device 100 is constituted by including a crosshead 101, an upper load cell 102, a test piece holding jig 103, a lower load cell 104, a lifting and lowering portion 106, and an electrodynamic actuator 110. A test piece 105 can be fixed to the test piece holding jig 103 with a predetermined bending h due to preload.

The electrodynamic actuator 110 in FIG. 2 is constituted by including a displacement sensor 111, an attaching surface 112, an excitation coil 113, a drive coil 114, a yoke 115, a vibration table 116, an upper guide 117, and a lower guide 118. Additionally, the air receiving portion (air spring) 123 formed inside the electrodynamic actuator 110 is constituted by including a receiving surface 120, an air room 121, and an air joint 122. The air pressure of the air receiving portion 123 can be changed by supplying the air stored in an air tank (not illustrated) to the air receiving portion 123 via control of the switching operation of a valve or the like by the air pressure control portion 4, or discharging the air from the air receiving portion 123.

The excitation coil 113 and the drive coil 114 constitutes a voice coil motor, and by passing an alternating current through the drive coil 114, while passing a direct current through the excitation coil 113, the drive coil 114 applies a vibration force to the vibration table 116 at a frequency according to the frequency of the alternating current. Accordingly, the vibration force is applied to the test piece 105 that is fixed by the holding jig 103. In parallel to this, by statically or quasi-statically changing the air pressure in the air room 121, a static or quasi-static vibration force by the air pressure is applied to the vibration table 116, in addition to the vibration force by the drive coil 114.

### Other Modes of Actuator

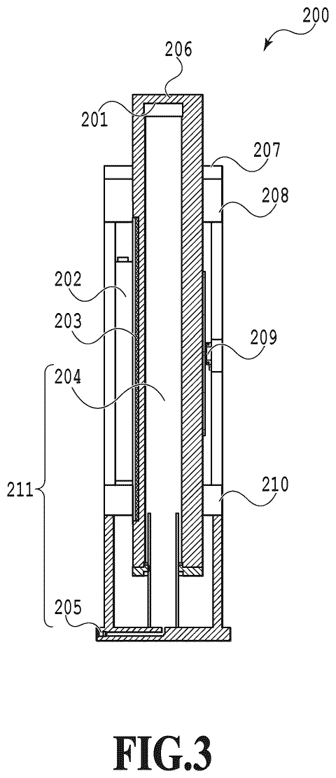

As another embodiment of the present invention, a linear actuator 200 as illustrated in FIG. 3 can also be used instead of the electrodynamic actuator 110. The linear actuator 200 is constituted by including a receiving surface 201, a primary-side coil 202, a secondary-side magnet 203, a vibration table 206, an attaching surface 207, an upper guide 208, a displacement sensor 209, and a lower guide 210. Additionally, the air room 204 and the air joint 205 constitute an air receiving portion (air spring) 211.

In this manner, the dynamic test device can be constituted not only by the aforementioned combination of the electrodynamic vibrator and the air spring, but also by the linear actuator 200 using the combination of the linear motor and the air spring, and the same effects as those in the case of using the aforementioned electrodynamic actuator 110 can be obtained.

As a further example, the dynamic test device may be constituted by a combination of a hydraulic vibrator and an air spring.

### Example of Dynamic Test

FIG. 4A, FIG. 4B, and FIG. 5 illustrate two examples of a dynamic test that can be performed in the dynamic test device 100 according to the embodiment of the present invention.

FIG. 4A and FIG. 4B illustrate graphs in a case of performing a performance test of a test piece by using the displacement as a target value, according to a first example, and FIG. 4A illustrates the change over time in the displacement of the target value in control, i.e., the control signal that is input to the control apparatus of the dynamic test device 100 described above for FIG. 1. On the other hand, FIG. 4B illustrates the change over time in the force (load) generated by the electrodynamic actuator 110 based on the control signal illustrated in FIG. 4A.

This performance test applies a constant preload (bending) to perform dynamic vibration, measures the bending and load of the test piece, and obtains the dynamic stiffness and attenuation at a certain frequency of the test piece as the performance of that test piece. Depending on the number of the test, the test piece becomes hard or soft. In a case where the load is constant, when the test piece becomes hard, bending becomes small, and conversely, when the test piece becomes soft, bending becomes great. The present test is suitable for a test of a test piece, such as a component to be used in an environment where the component is subject to bending (displacement) of a constant magnitude.

Here, for example, after applying a constant preload so that the initial position of the test piece becomes 6 mm as illustrated in FIG. 4A, a dynamic vibration force is applied so that the frequency becomes 10 Hz and the displacement becomes ±5 mm. At this time, when the spring constant of the test piece is 100 N/mm, as illustrated in FIG. 4B, the force generated by the electrodynamic actuator 110, i.e., the load applied to the test piece, is 600±500 N. Note that the initial position of the test piece is an example, and it is of course not limited to this.

FIG. 5 illustrates the change over time in the load generated in the case of performing the test by using the load as a target value, according to a second example. This test performs the endurance test of the test piece, the endurance test is generally based on a load, and the load serves as a target value. That is, in this example, the control signal (target value) that is input to the control apparatus of the dynamic test device 100 described above for FIG. 1 becomes the same as the force generated by the electrodynamic actuator 110 illustrated in FIG. 5.

The endurance test examines durability by performing continuous vibration with a test pattern waveform illustrated in FIG. 5. This endurance test is suitable for a test using a test piece such as a component that is used in an environment where the component is always subject to a constant load. Additionally, a user sets the frequency and magnitude of the load to be applied, according to the condition of use of the test piece.

For example, when the preload applied to the test piece is 600 N, and dynamic vibration is applied so that the frequency is 10 Hz and the change in the load is ±500 N, the variation in the load that occurs as illustrated in FIG. 5 is 1100 N at maximum, and 100 N at minimum.

### Description of Control System Model

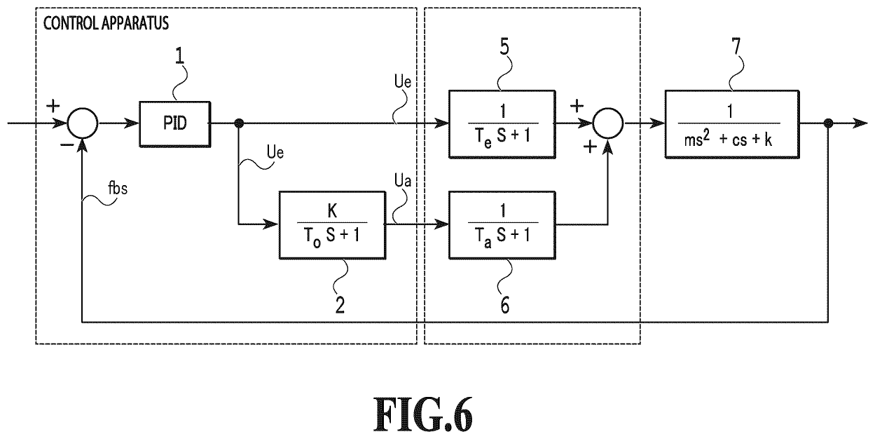

FIG. 6 is a block diagram representing a control system model of the dynamic test device 100 illustrated in FIG. 1.

A main vibrator 5 illustrated in FIG. 6 is constituted by including the power amplifier 3 and the actuator of the dynamic test device 100 described above for FIG. 1, and its response characteristics can be represented as a first-order lag system. Additionally, an air portion 6 is similarly constituted by including the air pressure control portion 4 and the air receiving portion (air spring) 123 of the dynamic test device 100 described above for FIG. 1, and its response characteristics can also be represented as a first-order lag system. Further, a vibrated portion 7 is a portion that is vibrated by the vibration of the test piece and its holding jig, and its response characteristics are represented as a second-order lag system.

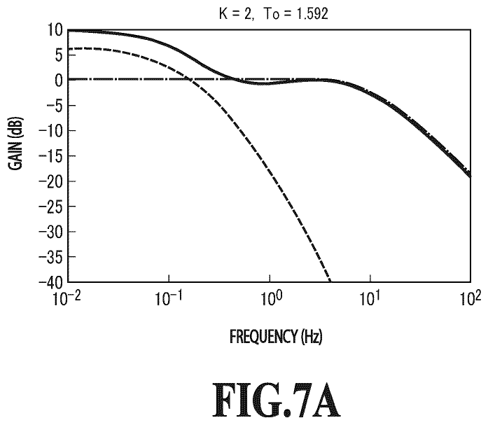

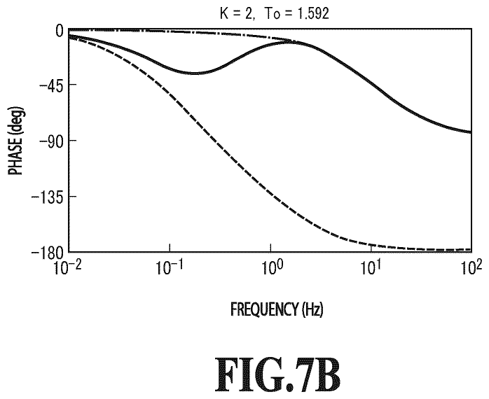

As described above for FIG. 1, the control signal of the target value that is input to the control apparatus is input to the main vibrator 5 and is also input to the filtering portion 2 as the control signal Ue that has passed through the PID control portion 1. In this filtering portion 2, a transfer function is represented by K/(T₀S+1) of a first-order lag system, and as will be specifically described later for FIG. 7A and FIG. 7B, and the filtering portion 2 constitutes a low pass filter (primary filter) that passes a relatively low-frequency component of the input control signal Ue, and reduces a relatively high-frequency component. More specifically, the control signal Ua that is output from the filtering portion 2 has a value K times the control signal Ue sent to the main vibrator 5, and has the gain and phase characteristics of the time constant T₀. Here, K and T₀are adjustable, and the air portion 6 can receive the load applied from the vibration portion in a static region of vibration by adjusting K by the control apparatus.

FIG. 7A and FIG. 7B are diagrams for describing the frequency characteristics of the filtering portion 2 illustrated in FIG. 6, and illustrate the characteristics in a case where K=2 and the time constant T₀=1.592 as an example. FIG. 7A illustrates a gain diagram, and FIG. 7B illustrates a phase diagram, respectively. In FIG. 7A and FIG. 7B, a broken line indicates the frequency characteristics of the filtering portion 2, and a one-dot-chain line indicates the frequency characteristics of an open loop transfer function including the control system, the power amplifier 3, and the actuator of the dynamic test device 100 in a case without the filtering portion 2 and the air portion 6 in FIG. 6. In addition, a solid line indicates the frequency characteristics of the control system of the present embodiment illustrated in FIG. 6, i.e., the control system including the filtering portion 2, the air portion 6, and the main vibrator 5.

The frequency characteristics of the filtering portion 2 is indicated by the broken line in FIG. 7A. Here, the relationship between a frequency f₀ and the time constant T₀ is f₀=1/(2πT₀), and the same also applies to the following. When T₀=1.592, the gain begins to decrease at a frequency of 0.1 Hz [1/(2πT₀)]. That is, the filtering portion 2 passes a frequency component of an input signal in a region (hereinafter also referred to as the “quasi-static region”) where the frequency is equal to or less than 1/(2πT₀) Hz (0.1(10⁻¹ Hz) in the example illustrated in the figure; hereinafter referred to as the “cutoff frequency”), and reduces a frequency component higher than 1/(2πT₀) Hz. In addition, in this quasi-static region, in the example where K=2, the air portion 6 bears ⅔ of the static load of the vibrated portion 7, and the main vibrator 5 bears ⅓. In this manner, since the filtering portion 2 (and air portion 6) exists, in the entire control system of the present embodiment, the control of the main vibrator 5 and the air portion 6 can be performed in association with each other in the quasi-static area as indicated by the solid lines, and this makes it possible to perform stable vibration control despite the difference in the responsiveness between the main vibrator 5 and the air portion 6. Additionally, as illustrated in FIG. 7A and FIG. 7B, in a high-frequency region having a frequency of 10 Hz or more that affects the stability, there is no increase in the gain and no delay in the phase, and the same frequency characteristic as in the case without the filtering portions 2 and air portion 6 is exhibited.

Note that the values illustrated above for the time constant T₀ and the K value are examples, and these values are of course defined according to a system realized by the dynamic test device. Additionally, the K value is determined by taking into consideration the stability of the control system. Further, the time constant T₀ is set to a large value in consideration of the frequency range of the load borne by the air pressure and to achieve a low frequency. On the other hand, when the time constant T₀ is small, since the influence of the high-frequency region becomes great, adjustment is performed so as to make the gain K small.

As described above, for the force generated by the main vibrator 5 and the force generated by the air portion 6, since the air portion 6 responds to the static or quasi-static response of the test piece, while bearing the load corresponding to the preload to the test piece, the control instability can be eliminated. That is, the displacement of the test piece can be held at a predetermined position, the test piece can also be held at a predetermined load position, and it is possible to prevent the test piece from moving without being held at a target position.

### Other Example of Control System Model

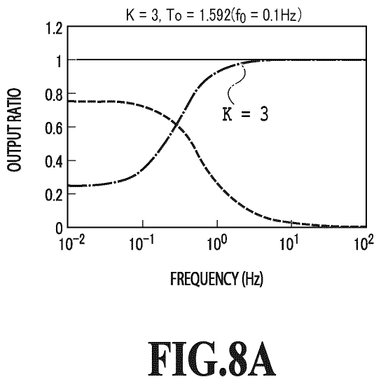

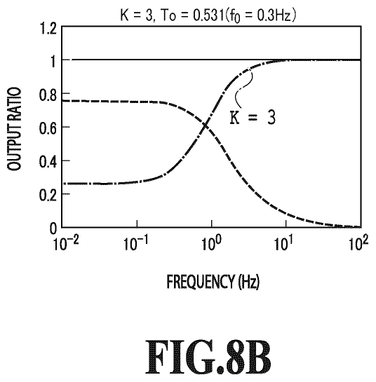

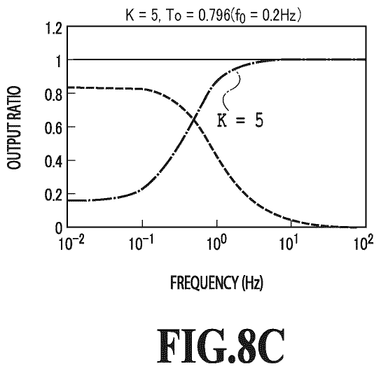

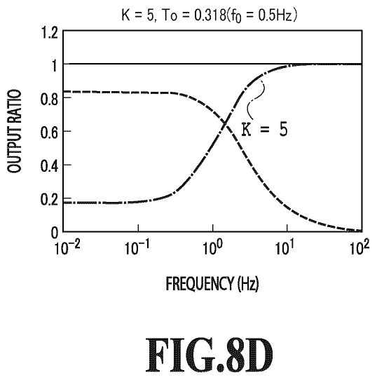

FIGS. 8A to 8D illustrate four examples in a case where the gain K and the time constant T₀ (cutoff frequency f₀ ) are changed, and are graphs representing simulation results of the control system model in FIG. 6. FIG. 8A is a graph illustrating the change in the output ratio with respect to the change in the frequency in a case where K=3, T₀=1.592, and f₀=0.1 (Hz), FIG. 8B is a graph illustrating the change in the output ratio with respect to the change in the frequency in a case where K=3, T₀=0.531, and f₀=0.3 (Hz), FIG. 8C is a graph illustrating the change in the output ratio with respect to the change in the frequency in a case where K=5, T₀=0.796, and f₀=0.2 (Hz), and FIG. 8D is a graph illustrating the change in the output ratio with respect to the change in the frequency in a case where K=5, T₀=0.318, and f₀=0.5 (Hz).

In FIGS. 8A to 8D, a solid line indicates a required vibration signal, a broken line indicates a vibration signal of the air portion 6, and a one-dot-chain line indicates a vibration signal of the main vibrator 5.

As can be seen from the graphs in FIGS. 8A to 8D, even if the parameters such as the gain K and the time constant To are varied, in a quasi-static area where the frequency is at 1 Hz or less, the air portion 6 is bearing most of a vibration output. On the other hand, it can be seen that the main vibrator 5 is bearing most of the vibration output in a high-frequency region where the frequency is at 10 Hz or more.

In this manner, the air portion 6 has low responsiveness, thus does not react to fast variation in a disturbance signal, and supplies the vibration signal only in the quasi-static region where the frequency is at 1 Hz or less. For fast variation in the signal having a high frequency, which influences stability, it is similarly maintained as in the case without the air portion.

### Change in Each Vibration Force Over Time

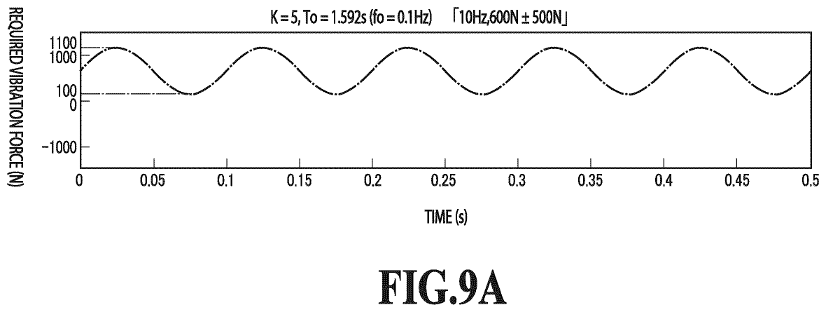

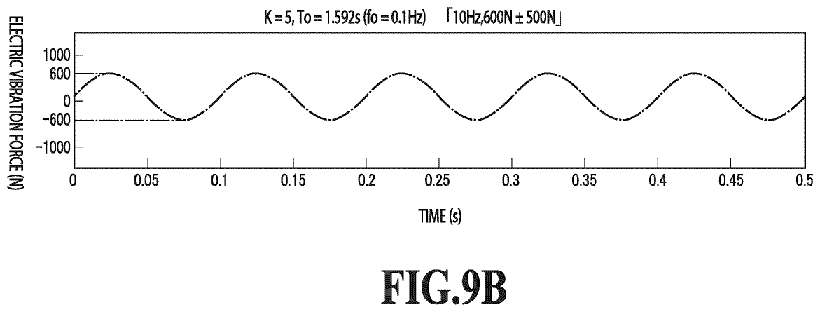

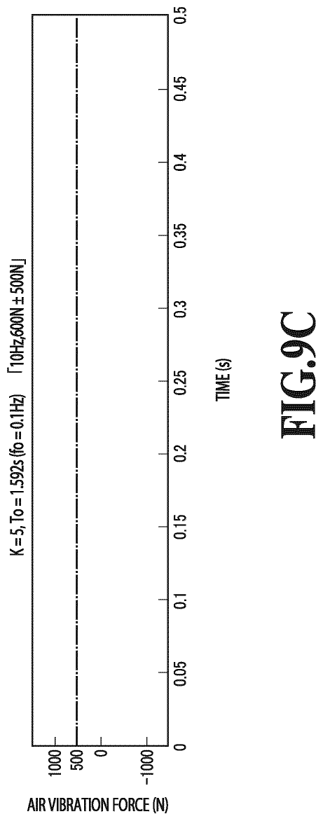

FIG. 9 is a graph representing the change in each vibration force in a case where a static vibration force is applied, FIG. 9A is a graph illustrating the change in a required vibration force over time in a case where K=5, f₀=0.1 Hz, and T₀=1.592, FIG. 9B is a graph illustrating the change in an electric vibration force over time, and FIG. 9C is a graph illustrating the change in a vibration force by air pressure over time.

Now, consider a case where the required static vibration force is 600 N, and the required dynamic vibration force is ±500 N at a frequency of 10 Hz. Then, when only the main vibrator 5 bears the vibration force required to vibrate the test piece as illustrated in FIG. 9A, the required vibration force is 1100 N at maximum. On the other hand, in a case where the air portion 6 is used to bear a part of the static load, when the gain K=5, the static load borne by the main vibrator 5 becomes 1/(5+1) times 600 N, which is 100 N. The static load borne by the air portion 6 is 5/(5+1) times 600 N, which is 500 N. Accordingly, the variation in the vibration force of the main vibrator 5 over time becomes ±600 as illustrated in FIG. 9B, and the variation in the vibration force of the air portion 6 over time becomes constant at 500 N as illustrated in FIG. 9C.

When the main vibrator 5 bears the static load (preload), it is necessary to always pass a constant current to generate a force. Therefore, energy will always be consumed. Additionally, since a part of the vibration capability is used for the static load, the vibration capability is insufficient for the required dynamic vibration force, and the need for a larger vibration apparatus arises, the energy will be further consumed and the energy efficiency is reduced.

When the air portion 6 is used to bear the static load (preload), since the air portion 6 can maintain the pressure constant by closing a valve, the air may be replenished for slight air leakage, and the energy consumption can be reduced compared with the case of the main vibrator 5 only.

In this manner, by increasing the static load borne by the air portion 6, the static load borne by the main vibrator 5 can be reduced, the energy consumption of the dynamic test device can be reduced, and the energy efficiency can be improved.

### Change in Each Vibration Force Over Time

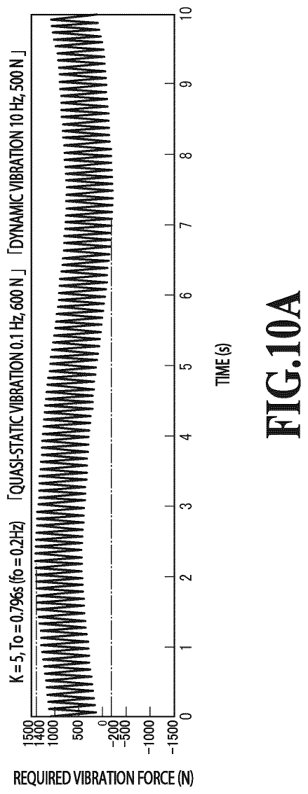

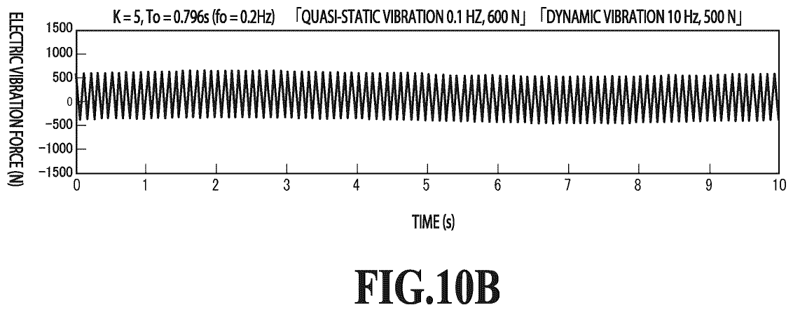

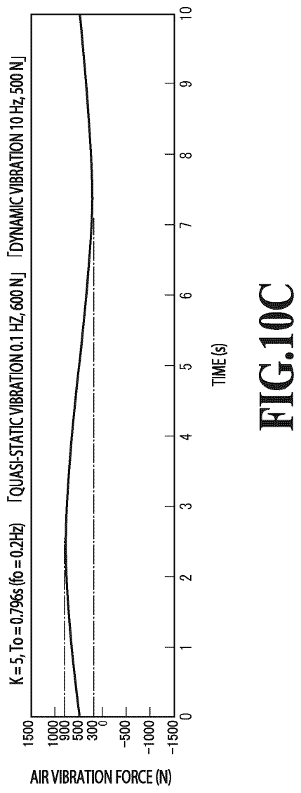

FIG. 10 is a graph representing the change in each vibration force over time in a case where a quasi-static vibration force is applied, FIG. 10A is a graph illustrating the change in the required vibration force over time when K=5, f₀=0.2 Hz, and T₀=0.796, FIG. 10B is a graph illustrating the change in the electric vibration force over time, and FIG. 10C is a graph illustrating the change in the vibration force by air pressure over time.

Now, consider a case where the required quasi-static vibration force is 600±300 N at a frequency of 0.1 Hz, and the required dynamic vibration force is ±500 N at a frequency of 10 Hz. Then, when only the main vibrator 5 bears the vibration force required to vibrate the test piece as illustrated in FIG. 10A, the required vibration force is 1400 N at maximum. On the other hand, in a case where the air portion 6 is used to bear the entire quasi-static load, when the gain K=5, the static load borne by the main vibrator 5 is 0 N. The static load borne by the air portion 6 is 900 N at maximum, and is 300 N at minimum. Accordingly, the variation in the vibration force of the main vibrator 5 over time becomes ±500 as illustrated in FIG. 10B, and the variation in the vibration force of the air portion 6 over time becomes 900 N at maximum and 300 N at minimum as illustrated in FIG. 10C.

In this case, since the air portion 6 bears the quasi-static load that is varied at 0.1 Hz, the energy efficiency in the main vibrator 5 can be further improved compared with the aforementioned case.

### REFERENCE SIGNS LIST

1 PID Control Part

2 filtering portion

3 power amplifier

4 air pressure control portion

5 main vibrator

6 air portion

7 vibrated portion

100 dynamic test device

102 upper load cell

103 test piece holding jig

104 lower load cell

105 test piece

110 electrodynamic actuator

113 excitation coil

114 drive coil

116 vibration table

120 receiving surface

121 air room

122 air joint

123 air spring

200 linear actuator

1. A dynamic test device that vibrates a test piece, the dynamic test device comprising:
a vibration portion comprising a holding portion capable of holding the test piece, and configured to be able to reciprocate the holding portion holding the test piece;
first vibration means that reciprocates the vibration portion to vibrate the vibration portion;
second vibration means that reciprocates the vibration portion to vibrate the vibration portion; and
control means for controlling the first vibration means and the second vibration means to vibrate the vibration portion,
wherein the control means controls the first vibration means and the second vibration means based on the same control signal, so that individual vibration by the first vibration means and the second vibration means is performed in a static area of a quasi-static area of vibration.

2. The dynamic test device according to claim 1, wherein the control means generates, based on a control signal that is input, a first signal for controlling the first vibration means, and a second signal for controlling the second vibration means and filtered by a filtering portion including a low pass filter.

3. The dynamic test device according to claim 2, wherein a transfer function of the filtering portion is represented by the following formula: K/(T₀S+1) including a gain K and a time constant T₀, and K and T₀ are adjustable.

4. The dynamic test device according to claim 3, wherein the control means bears a load received by the second vibration means from the vibration portion in a static area or a quasi-static area of vibration by adjusting K.

5. The dynamic test device according to claim 1,
wherein a sensor that measures vibration of the test piece is attached to the dynamic test device, and
wherein the control means controls the first vibration means and the second vibration means based on a measurement result of the senor.

6. A control method of a dynamic test device that vibrates a test piece, the method comprising:
preparing
a vibration portion comprising a holding portion capable of holding the test piece, and configured to be able to reciprocate the holding portion holding the test piece,
first vibration means that reciprocates the vibration portion to vibrate the vibration portion, and
second vibration means that reciprocates the vibration portion to vibrate the vibration portion;
controlling the first vibration means and the second vibration means to vibrate the vibration portion and controlling the first vibration means and the second vibration means based on the same control signal, so that individual vibration by the first vibration means and the second vibration means is performed in a static area of a quasi-static area of vibration.

7. The control method according to claim 6, wherein, based on a control signal that is input, a first signal for controlling the first vibration means and a second signal for controlling the second vibration means and filtered by a filtering portion including a low pass filter are generated.
